(19) United States
(12) Patent Application Publication
(10) Pub. No.: US 2026/0332258 A1
(43) Pub. Date: Oct. 22, 2026

(54) ENTANGLEMENT ASSISTED COMMUNICATION OVER TURBULENT FREE-SPACE OPTICAL LINKS USING ADAPTIVE OPTICS AND PHASE CONJUGATION ON IDLER PHOTONS

(71) Applicant: ARIZONA BOARD OF REGENTS ON BEHALF OF THE UNIVERSITY OF ARIZONA, Tucson, AZ (US)

(72) Inventors: Ivan B. Djordjevic, Tucson, AZ (US); Vijay Nafria, Tucson, AZ (US)

(21) Appl. No.: 19/486,815

(22) PCT Filed: May 25, 2024
(86) PCT No.: PCT/US2024/031173

§ 371 Date: Nov. 21, 2025

Related U.S. Application Data
(60) Provisional application No. 63/504,555, filed on May 26, 2023.

(51) Int. Cl. H04B 10/11; G02F 1/39; H04B 10/63; H04B 10/70

(52) U.S. Cl. CPC H04B 10/11; G02F 1/395; H04B 10/63; H04B 10/70

(57) ABSTRACT

Disclosed are systems and techniques for entanglement-assisted communication using adaptive optics and phase conjugation of idler photons. A first periodically poled lithium niobate (PPLN) waveguide generates entangled signal-idler photon pairs using spontaneous parametric down-conversion of a first portion of an amplified beam. A demultiplexer separates signal and idler photons. The signal photons are modulated to generate modulated signal photons for transmission, and the idler photons are kept at the transmitter. A remaining pump power after the first PPLN waveguide is also transmitted and used by receiver adaptive optics to apply corrections to a received beam that includes the modulated signal photons. The remaining pump power is used as the reference signal for a homodyne receiver. The idler photons are phase-conjugated using a second PPLN waveguide, stored in an optical delay line, and

### CROSS-REFERENCE TO RELATED APPLICATIONS

This is a PCT application that claims benefit to U.S. Provisional Application No. 63/504,555, filed May 26, 2023, which is hereby incorporated by reference, in its entirety and for all purposes.

### FIELD

The present disclosure generally relates to quantum information processing (QIP), and in particular, relates to a system and associated method for entanglement-assisted (EA) communication over turbulent free-space optical (FSO) links.

### BACKGROUND

Quantum information processing (QIP) opens new avenues for numerous applications, including high-performance computing, high-precision sensing, and secure communications. Among various QIP attributes, entanglement is a unique QIP feature and may be used to implement quantum computers capable of solving problems that are numerically intractable for classical computers. Entanglement-based approaches may also lead to quantum-enhanced sensors with measurement sensitivities that exceed classical limits.

For example, entanglement represents a unique quantum information processing (QIP) attribute that can enable: (1) outperforming classical sensor sensitivity; (2) unconditional security for future communication networks; and (3) exceeding classical channel capacities. Additionally, pre-shared entanglement can enable distributed quantum sensing and/or secure distributed quantum computing. In some cases, entanglement can be seen to enable quantum sensors with a sensitivity better than the standard quantum limit, communications with a spectral efficiency greater than the Shannon limit, secure communication with security guaranteed by the QIP theorems, distributed quantum sensing, and secure distributed quantum computing, among various others.

To utilize unique capabilities of entanglement, quantum communication links can be used to distribute entanglement to remote nodes. To distribute entanglement, fiber-optic based links can be used. In some examples, to enable wider area and/or global coverage, entanglement can be distributed by satellite-to-ground links. However, satellite-to-ground links may introduce relatively long propagation delays.

It is with these observations in mind, among others, that various aspects of the present disclosure were conceived and developed.

### SUMMARY

The present disclosure provides a number of examples of an inventive concept including systems and methods for entanglement distribution and/or entanglement-assisted (EA) communication over turbulent free-space optical (FSO) links or other atmospheric channels. In the context of the disclosed methods, devices, techniques, apparatus, systems, and so on, the terms “operable to,” “configured to,” and “capable of” used herein are interchangeable.

In one illustrative example, a method for entanglement assisted communications is provided, the method including: splitting an amplified pump beam into a first portion and a second portion; providing the first portion of the amplified pump beam to a first periodically poled lithium niobate (PPLN) waveguide; generating, using the first PPLN waveguide, entangled photon pairs comprising signal photons and idler photons, wherein the first PPLN waveguide generates the entangled photon pairs using a spontaneous parametric down-conversion (SPDC) process; separating, using a wavelength-division multiplexing (WDM) demultiplexer, the signal photons and the idler photons from the output of the first PPLN waveguide, wherein the signal photons are provided to a modulator to generate modulated signal photons, and wherein the idler photons are kept in quantum memory; and transmitting the modulated signal photons using the transmitter, wherein a remaining pump power after the first PPLN waveguide is also included in a transmitted beam of the transmitter and is used as a reference or beacon beam to operate an adaptive optics (AO) subsystem of a receiver associated with the transmitter.

In some aspects, processing the idler photons at the transmitter comprises: combining the idler photons with the second portion of the amplified pump beam; performing phase conjugation using a second PPLN waveguide, wherein the second PPLN waveguide receives as input the idler photons combined with the second portion of the amplified pump beam; providing an output of the second PPLN waveguide to the WDM demultiplexer to bandpass phase-conjugated idler photons; and distributing the phase-conjugated idler photons to the receiver using an optical fiber.

In some aspects, the signal photons are associated with a wavelength of 1550 nanometers (nm); the idler photons are associated with a wavelength of 1510 nm; and the phase-conjugated idler photons are associated with a wavelength of 1550 nm.

In some aspects, keeping the idler photons at the transmitter further comprises passing the 1550 nm phase-conjugated idler photons through a length of the optical fiber, where the optical fiber is configured as an optical delay line (ODL) to distribute the phase-conjugated photons to the receiver; and the length of the optical fiber configured as the ODL is selected to match a propagation delay of the signal photons transmitted over a turbulent free-space optical (FSO) link between the transmitter and the receiver.

In some aspects, the second PPLN waveguide performs optical phase conjugation using a difference frequency generation (DFG) process.

In some aspects, the method further comprises: using a receiver to receive a beam associated with the modulated signal photons transmitted over a free-space optical (FSO) link by the transmitter; providing the received beam to an adaptive optics (AO) subsystem of the receiver, wherein the AO subsystem uses an unused pump signal included in the transmitted beam as the reference or beacon beam for determining a correction for applying to a deformable mirror to compensate for turbulence on the FSO link between the transmitter and the receiver; and controlling the deformable mirror to receive the received beam while deforming in response to the correction determined by the AO subsystem, wherein the deformation of the deformable mirror generates a compensated received beam.

In some aspects, the AO sub-system includes a wavefront sensor (WFS), the deformable mirror, and a computing device; and the WFS and the deformable mirror operate in a feedback servo loop.

In some aspects, a beam splitter provides a first portion of the compensated received beam to the WFS for determining the correction to apply to the deformable mirror; and the beam splitter provides a remaining portion of the compensated received beam to a balanced detector via a multimode fiber.

In some aspects, the balanced detector is included in a homodyne receiver configured to determine phase information; the homodyne receiver includes the balanced detector and an optical hybrid; and the balanced detector is free-space coupled such that a large core multi-mode fiber (MMF) can be used to couple received signal photons into the MMF.

In some aspects, the second PPLN waveguide is used to perform optical phase-conjugation on the combination of the idler photons and the second portion of the amplified pump beam; and the phase-conjugated idler photons are delayed using an optical fiber to distribute the phase-conjugated idler photons to the receiver, wherein the optical fiber comprises a reconfigurable optical delay line (ODL); and the optical fiber comprising the ODL is configured to delay the phase-conjugated idler photons to the receiver such that an overall delay applied to the phase-conjugated idler photons by the ODL matches a propagation delay of signal photons transmitted over a turbulent FSO channel and provided to the homodyne detector as a local oscillator (LO) signal.

In some aspects, a length of a distribution fiber of the ODL is configured to delay the phase-conjugated idler photons such that an arrival time of the delayed phase-conjugated idler photons is the same as an arrival time of the returning signal photons from the receiver.

In some aspects, a transmitted beam from the transmitter includes the modulated signal photons and an unused pump power signal of the first PPLN waveguide that are transmitted over a turbulent free-space optical (FSO) link; and the received beam obtained by the receiver is either a reflected or a redirected beam from an intermediate node, or a direct beam from a remote transmitter.

In some aspects, the transmitter and the receiver are associated with communicating parties each capable of bidirectional transmission, wherein a respective transmitter and a respective receiver of each communicating party are included in a corresponding FSO transceiver associated with each communicating party.

In some aspects, the method further comprises using a tunable laser to generate a beam at a configured wavelength; and generating, using an amplifier connected to an output of the tunable laser, an amplified beam at the configured wavelength and with an increased power.

In some aspects, the tunable laser comprises an S-band laser diode, a C-band laser diode, or an L-band laser diode; and the amplifier comprises an Erbium-Doped Fiber Amplifier (EDFA).

In some aspects, the configured wavelength associated with the tunable pump laser and the EDFA is 1529.75 nanometers (nm); or the configured wavelength is selected based on tuning the tunable laser to a particular wavelength within one or more of S-, C-, or L-band wavelengths associated with the tunable laser.

In some aspects, the signal photons have a wavelength of 1550 nanometers (nm) and the idler photons have a wavelength of 1510 nm.

In some aspects, the demultiplexer is a wavelength-division multiplexing (WDM) demultiplexer.

In some aspects, the phase conjugation of idler photons is performed on a receiver side or by a receiver of an entanglement assisted communication system.

In some aspects, the phase conjugation of idler photons is performed on an intermediate node included between a transmitter and a receiver of an entanglement assisted communication system.

In another illustrative example, an apparatus for entanglement assisted communications is provided. The apparatus includes several transceiver modules configured to: split an amplified pump beam into a first portion and a second portion; provide the first portion of the amplified pump beam to a first periodically poled lithium niobate (PPLN) waveguide; generate, using the first PPLN waveguide, entangled photon pairs comprising signal photons and idler photons, wherein the first PPLN waveguide generates the entangled photon pairs using spontaneous parametric down-conversion (SPDC); separate, using a wavelength-division multiplexing (WDM) demultiplexer, the signal photons and the idler photons from the output of the first PPLN waveguide, wherein the signal photons are provided to a modulator to generate modulated signal photons, and wherein the idler photons are kept at a transmitter and after phase-conjugation distributed to the receiver; and transmit the modulated signal photons using the transmitter, wherein a remaining pump power after the first PPLN waveguide is also included in a transmitted beam of the transmitter and is used as a reference or beacon beam to operate an adaptive optics (AO) subsystem of a receiver associated with the transmitter.

The foregoing examples broadly outline various aspects, features, and technical advantages of examples according to the disclosure in order that the detailed description that follows may be better understood. It is further appreciated that the above operations described in the context of the illustrative example method, device, and computer-readable medium are not required and that one or more operations may be excluded and/or other additional operations discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

FIG. 1 is a simplified diagram showing an example block diagram representation of an entanglement-assisted (EA) communication system that can be used to provide EA communications over a turbulent free-space optical (FSO) link, in accordance with some examples;

FIG. 2 is a graph showing an example of bit-error rate (BER) of EA communications over an FSO link with and without the use of adaptive optics (AO), in accordance with some examples;

FIG. 3 is a graph showing an example of BER in a back-to-back configuration comparing EA and classical laser communications, in accordance with some examples; and

FIG. 4 is a graph showing examples of BER for different turbulence instances (realizations), demonstrating that EA communication in the beyond strong turbulence regime outperforms classical communication in the medium turbulence regime.

### DETAILED DESCRIPTION

Aspects of the present disclosure provide systems and methods for improving the reliability of entanglement-assisted (EA) communication over turbulent free-space optical (FSO) channels or links. In particular, entangled photon pairs can be generated and distributed over turbulent FSO channels, using, for example, an entanglement distribution system or an EA-assisted quantum communication system. In one illustrative example, phase conjugation can be performed on idler photons (e.g., included in an entangled pair of idler-signal photons) that are generated and stored locally at the transmitter of the EA communication system, rather than performing the phase conjugation on turbulence-affected signal photons that are also generated by the transmitter but are then sent over a turbulent FSO channel to a receiver. In some aspects, implementing the phase conjugation for idler photons can improve the reliability of EA communication over turbulent FSO channels. In some embodiments, adaptive optics (AO) may be used to further improve the reliability of EA communication over turbulent FSO channels. Described herein is an experimental demonstration of reliable EA communication over an outdoor, terrestrial (e.g., turbulent) FSO link.

Entanglement is a key quantum information processing (QIP) feature enabling quantum communication, networking, and sensing (among various others). For example, in quantum communication techniques, information may be transmitted using quantum states of photons. Entanglement is a quantum phenomenon where two or more particles (e.g., two or more photons, etc.) are correlated such that the state of one particle cannot be described independently of the others. Entangled particles such as photons can theoretically be used to transmit quantum information over very long distances. However, functional limits on the maximum reliable or useful range of entanglement distribution can arise due to physical limitations and losses associated with the transmission of photons through a medium (e.g., such as optical fibers, etc.).

For example, long-distance quantum communication is affected by the photon loss associated with the photons traveling through a medium such as optical fiber. As the photons travel through the medium, some of the photons may be lost due to various factors such as absorption, scattering, and/or imperfections in the transmission channel. The “photon loss” can refer to or quantify the loss of photons over the transmission channel (e.g., along the path from the transmitter to the receiver). Moreover, unlike classical signals, quantum signals cannot be amplified without disturbing their information-bearing entangled quantum state. In particular, quantum signals cannot be amplified without introducing additional noise that degrades or even destroys the transmitted entanglement.

As such, the classical signal transmission approach of amplifying weak signals to compensate for the loss cannot be utilized for quantum communications, and the photon loss can limit the distance over which quantum information can be reliably transmitted. The longer the transmission distance, the greater the photon loss and the weaker the quantum signal becomes at the receiver, which can decrease the fidelity and reliability of quantum communications and/or quantum information transmission. Quantum communication techniques may therefore require fundamentally distinct loss-mitigation mechanisms to establish long-range entanglement.

As an alternative, free-space optical (FSO) links can be used instead for performing the underlying entanglement distribution associated with EA communications or other quantum communications/information exchanges. FSO links can be implemented based on using light propagating in free space to transmit information between two points. For example, rather than using optical fibers or waveguides to guide the light signal, FSO-based communication techniques allow photons to propagate in free space between the transmitter and the receiver, using the atmosphere as the transmission medium. However, FSO links can be strongly affected (e.g., limited) by the presence or occurrence of atmospheric turbulence effects, in addition to scattering effects and/or various other atmospheric conditions or behaviors that can reduce the signal quality and performance of FSO links.

Systems, apparatuses, processes (also referred to as methods), and computer-readable media (collectively referred to as “systems and techniques”) are described herein that can be used to perform EA communications and/or entanglement distribution using phase conjugation for idler photons and further using adaptive optics to improve the fidelity of entanglement when entangled states (e.g., signal photons associated with the phase conjugated idler photons at the EA transmitter) are distributed over turbulent FSO links.

To exploit or otherwise utilize unique capabilities of entanglement, quantum communication fiber-optic links may be used to distribute entanglement to remote nodes. In many existing approaches, optical phase-conjugation (OPC) is required to perform EA communication. In particular, it is common practice in existing approaches to perform the required OPC on signal photons at the receiver side (e.g., the transmitter first generates the entangled pair of signal and idler photons, transmits the signal photon to the receiver, and the receiver performs OPC on the received signal photons from the transmitter). Described herein are systems and techniques that can be used to perform EA communication using OPC performed on idler photons, which notably can be performed at the transmitter-side without involvement of photons that must first be transmitted/received over a turbulent channel prior to the OPC. Alternatively, the OPC on idler photons can be performed at an intermediate node or, in some embodiments, can be performed at a receive node.

Signal photons are often severely affected by FSO channel impairments, including turbulence on the FSO channel. In particular, many signal photons are usually absorbed or scattered by the turbulence on the FSO channel. Moreover, the entanglement of a signal-idler photon pair can be completely destroyed by a highly turbulent FSO channel. Advantageously, by performing the OPC on bright idler photons at the transmitter (rather than performing the OPC on impaired signal photons received over the turbulent FSO channel), the systems and techniques can implement very reliable and efficient OPC operations for EA communications (e.g., based on the idler photons not being transmitted over the turbulent FSO channel, and therefore not being affected by FSO channel impairments). Further still, adaptive optics (AO) can be used to further reduce the atmospheric turbulence effects on the signal photons thus improving the reliability of the EA communications.

### Experimental Details

Further described are results from FSO communication experiments where entangled photon pairs were generated and separated into signal and idler photons using a wavelength-division multiplexing (WDM) demultiplexer. The signal photons can be modulated by imposing a binary phase shift keying (BPSK) sequence, for example using a phase modulator. The example of a BPSK scheme is provided for illustrative purposes, and various other modulation schemes can also be utilized without departing from the scope of the disclosure (e.g., BPSK can be replaced with a quadrature phase-shift keying (QPSK) scheme, M-ary PSK, etc.). The idler photons can be stored in a quantum memory. Given that quantum memories are not commercially available, an optical delay line (ODL) of proper delay can be used instead of the quantum memory. For instance, the delay provided by the ODL can be configured, determined, or implemented based on a length of an optical fiber used for the ODL and/or based on a refractive index of the optical fiber used for the ODL. The modulated signal photons (e.g., from the phase modulator) are propagated over an outdoor, turbulent free-space optical (FSO) link. In some embodiments, the experimental approach described below utilizes a 1.45 kilometer (km) outdoor FSO link, although it is noted that other distances and/or FSO link configurations can also be utilized. At the receive side, the received modulated signal photons are coupled into multi-mode fiber and the phase information of the modulated signal photons is detected using a homodyne receiver. For instance, the homodyne receiver can include an optical hybrid and a balanced detector. The received modulated signal photons are one input to the homodyne detector, while idler photons (after the optical phase conjugation (OPC) has been performed) are used as the local oscillator (LO) signal. To facilitate implementation, the balanced detectors might employ free-space coupling to the detectors rather than fiber-based coupling. This EA scheme is highly flexible, the OPC of the idler photons can be performed on transmitter side, receiver side, or at an intermediate node. The remaining pump signal after the PPLN waveguide, serving as the wavelength converter and SPDC entangled source, is also transmitted and used as the reference (beacon) beam to operate the adaptive optics.

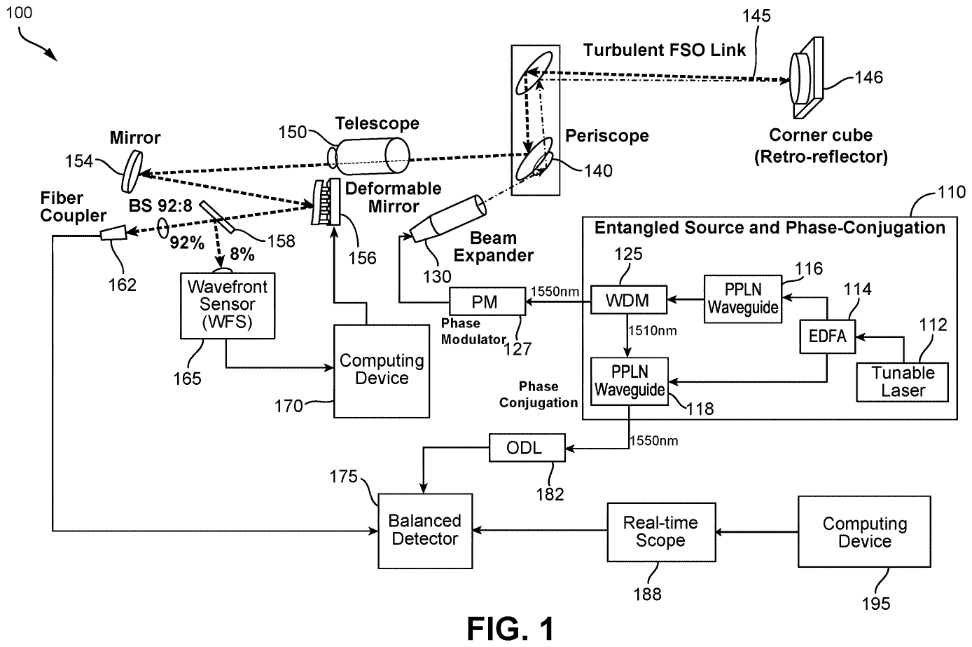

Further details are described below with respect to FIG. 1 and the example entanglement-assisted (EA) communication system 100 that can be used to perform EA communications over turbulent FSO channels using adaptive optics and optical phase conjugation (OPC) applied on idler photons. In some examples, the EA communication system 100 of FIG. 1 can be utilized in the context of experimental validation of the presently disclosed systems and techniques for improved EA communications over turbulent FSO channels. For instance, the EA communication system 100 may also be referred to herein as an experimental testbed, FSO testbed, etc.

In some aspects, the EA communication system 100 of FIG. 1 can comprise five different stages: a first stage for entangled photon pair generation; a second stage for separating idler photons and signal photons, and modulating signal photons; a third stage for transmitting an optical beam using an FSO transceiver and an FSO link; a fourth stage for obtaining a received (e.g., either reflected or direct) beam and applying adaptive optics (AO); and a fifth stage for performing entanglement assisted detection. Each stage of the example EA communication system 100 of FIG. 1 is described in turn below. First Stage (e.g., entangled photon pair generation): the first stage of the example EA communication system 100 of FIG. 1 can include entangled photon pair generation (e.g., to generate an entangled photon pair comprising a signal photon and an idler photon). In one illustrative example, the EA communication system 100 can perform entangled photon pair generation using an entangled source and phase-conjugation module 110. In some aspects, the entangled source and phase-conjugation module 110 can include a tunable laser 112 (e.g., a S-/C-/L-band laser diode or other tunable laser), an Erbium-Doped Fiber Amplifier (EDFA) 114, a first periodically poled lithium niobate (PPLN) waveguide 116 serving as the spontaneous parametric down-conversion (SPDC) module, and a second PPLN waveguide 118 serving as the optical phase-conjugation (OPC) module. The tunable laser 112 can also be referred to as a pump laser. In one illustrative example, the entangled source and phase-conjugation module 110 can be configured to generate entangled photon pairs using the tunable laser 112 (e.g., pump laser) tuned at 1529.75 nanometers (nm), further amplified by using a high-power Erbium-Doped Fiber Amplifier (EDFA) 114 connected to the output of the tunable laser 112.

The amplified output of the EDFA 114 can be split into two parts, as illustrated in FIG. 1. For example, a first amplified signal from the EDFA 114 (e.g., the upper amplified signal of FIG. 1, from the EDFA 114 to the first PPLN waveguide 116) can be passed through a properly designed and fabricated periodically poled lithium niobate (PPLN) waveguide 116 (e.g., the upper PPLN waveguide of FIG. 1).

A first portion or first half of the upper PPLN waveguide 116 can be used to perform the wavelength conversion to get the secondary pump. In the second portion or second half of the upper PPLN waveguide 116, the entangled photon pairs are generated by a parametric down conversion (PDC) process. In one illustrative example, 1550 nm and 1510 nm photon pairs are utilized as the signal and idler photons, respectively. However, it is noted that various other photon pairs and/or photon wavelengths can be used for the signal and idler photons, without departing from the scope of the present disclosure.

Second Stage (e.g., idler-signal photon separation): In the second stage of the example EA communication system 100 of FIG. 1, the system 100 can separate idler photons and signal photons included within the initial or intermediate output of the entangled source and phase-conjugation module 110 (e.g., where the initial or intermediate output of the entangled source and phase-conjugation module 110 is the output of the upper PPLN waveguide 116). In particular, the system 100 can use a wavelength-division multiplexing (WDM) demultiplexer 125 to separate idler photons and signal photons from the output of the first/upper PPLN waveguide 116.

For example, the WDM demultiplexer 125 can output the 1550 nm signal photons to a phase modulator (PM) 127 via a first output path from WDM demultiplexer 125 to the PM 127. The WDM demultiplexer 125 can output the 1510 nm idler photons to a second (e.g., lower) PPLN waveguide 118, via a second output path from the WDM demultiplexer 125 to the lower PPLN waveguide 118 serving the role of the phase-conjugation module.

From the WDM demultiplexer 125, the signal photons, at a wavelength of 1550 nm, can be modulated to perform the EA communications. For instance, the separated signal photons (e.g., 1550 nm photons) can be modulated using a phase modulator 127 (e.g., depicted as “PM” 127 in FIG. 1). In one illustrative example, the phase modulator 127 can be configured and used to apply low-density parity check (LDPC)-coded binary phase shift keying (BPSK) modulation to the separated signal photons received by the phase modulator 127 from the WDM demultiplexer 125, for example based on applying the BPSK signal to the RF input of the phase modulator 127.

In one illustrative example, the phase modulator 127 can use a code rate of 0.625501 and a codeword length of 3992 to LDPC encode and phase modulate the signal photons obtained from the WDM demultiplexer 125, wherein 2497 information bits and 1495 parity bits are included in the codeword length of 3992.

The idler photons, at a wavelength of 1510 nm are output by the WDM demultiplexer 125 on a separate and different output path than is used for the idler photons at wavelength 1510 nm, and can be kept or stored on either the transmitter side or the receiver side of EA communication system 100. The idler photons processing (e.g., processing of the idler photons) will be described in greater depth below with respect to the fifth stage (e.g., the photon detection stage) of the EA communication system 100.

Third and Fourth Stages (e.g., FSO transceiver and FSO link stages): The third and fourth stages of the example EA communication system 100 of FIG. 1 represent the FSO transceiver (e.g., comprising one or more of beam expander 130, periscope 140, and/or telescope 150), the turbulent FSO link 145, and the adaptive optics (AO) (e.g., including one or more of the deformable mirror 156, computing device 170, wavefront sensor (WFS) 165, etc.). As noted previously, the experimental approach and results described herein for the EA communication system 100 can be based on an experimental 1.45 km FSO link (e.g., the turbulent FSO link 145 used in round-trip fashion, i.e., in both directions between the periscope 140 and a corner cube retroreflector 146). For instance, an experimental 1.45 km FSO link 145 is provided on the campus of the University of Arizona.

The EA communication system 100 is shown in FIG. 1 as being divided into two physical locations. The transmitter, beam transmission/collection, detector/decoder, and AO subsystems are provided at a first location (e.g., ECE room 549 on the University of Arizona campus). A retroreflector 146 is placed at a second location (e.g., the rooftop of the OSC Meinel building on the University of Arizona campus) separate/distant from the first location, with a line-of-sight (LOS) there between for establishing the FSO link 145. In some aspects, the second location where the retroreflector 146 is provided may also be referred to as an intermediate location and/or an intermediate node. In some embodiments, the retroreflector 146 can be a retroflector corner cube or a properly designed mirror, etc., and can be used to redirect a beam transmitted from the FSO transmitter at the first location towards a third location (e.g., receiver location) when there is no line-of-sight directly between the transmitter and the receiver of the EA communication system 100. In this particular experimental demonstration, the corner cube retroreflector 146 directs the beam back towards the first location (e.g., ECE room 549, housing the periscope 140 from which the beam towards the retroreflector 146 originated) in order to double the transmission distance of the turbulent FSO link 145.

In one illustrative example, the optical beam obtained based on the phase-modulated output of the phase modulator 127 can be transmitted using a beam expander 130 coupled to the output of the phase modulator 130. A periscope 140 can be coupled to the beam expander 130 and may be used to transmit the optical beam onto or using the turbulent FSO link 145. In some embodiments, the combination of the beam expander 130 and the periscope 140 can be included in the FSO transmitter of the EA communication system 100. The combination of the beam expander 130 and the periscope 140 can also be referred to as the FSO transmitter. In some embodiments, the same periscope 140 (and same FSO transceiver) can be used to transmit the optical beam and to receive the redirected (e.g., reflected) beam from the retroreflector 146.

In some examples, the periscope subsystem 140 of the FSO transceiver can be composed of three mirrors. For example, two 6-inch mirrors can be provided with a first 6-inch mirror at the top of the periscope 140 and a second 6-inch mirror at the bottom of the periscope 140. One 2-inch mirror can additionally be provided at the bottom of the periscope 140. The top mirror of the periscope 140 can be a shared (e.g., common) mirror to a transmit configuration of the periscope 140 and a receive configuration of the periscope 140. For instance, in the transmit configuration of the periscope 140, the smaller bottom mirror and the shared top mirror can be used to transmit the transmitted beam from the periscope 140 to the retroreflector 146. In the receive configuration of the periscope 140, the shared top mirror and the larger bottom mirror can be used to receive the redirected, directed, or reflected beam from the retroreflector 146.

In some embodiments, the transmit and receive configurations of the periscope 140 can be combined into a single periscope or single periscope housing. In some examples, the transmit configuration of the periscope 140 can be provided by a transmit periscope that is separate from a receive periscope/the receive periscope configuration.

The transmitted optical beam from the beam expander 130 and the periscope 140 in the transmit configuration (e.g., transmit configuration of the FSO transceiver that includes the periscope 140) propagates over the turbulent FSO link 145 (e.g., the 1.45 km link between the first location and the second location/retroreflector) and is reflected (e.g., redirected) by the retroreflector 146 at the second location back towards the window of ECE room 549 (the first location).

Fourth Stage (e.g., Adaptive Optics stage): In the fourth stage of the example EA communication system 100 of FIG. 1, the received beam (either a reflected beam from a retroreflector 146 or mirror provided at an intermediate node, location, relay, etc.; or a direct beam transmitted directly by the FSO transceiver/beam expander 130 and periscope 140) is received using the shared top mirror and larger bottom mirror of the periscope 140 of the FSO transceiver (e.g., the receive configuration of the periscope 140).

The received beam can then be provided to a receive telescope 150. The receive telescope 150 can be a compressing telescope, for example used to reduce the size of the received beam. In some embodiments, the received beam is compressed by the telescope 150 on the optical bench and processed by the adaptive optics (AO) subsystem shown in FIG. 1. For instance, from the receive telescope 150, the received beam reflects off of a first mirror 154 and is provided next to a deformable mirror 156 of the AO subsystem.

In the AO subsystem, a wavefront sensor (WFS) 165 can be used to measure distortions in the wavefront. A deformable mirror (DM) 156 can be used in a servo feedback loop with the WFS 165 to undo (e.g., correct or compensate) the actions of the turbulent FSO channel 145. For instance, the deformable mirror 156 can be coupled to a computing device 170 for controlling the adaptive optics (AO). The portion of the beam reflected from the deformable mirror 156 and split into a portion for the WFS 165 by the beam splitter 158 is used by the WFS 165 to measure the distortions in the wavefront introduced by the turbulent channel 145. A correction algorithm (e.g., AO algorithm) is run on the computing device 170 to determine which forces the actuators of the deformable mirror 156 should apply in order to undo (e.g., correct or compensate) the turbulent action of the channel 145.

As noted above, the AO sub-system includes a wavefront sensor (WFS) 165 and a deformable mirror (DM) 156, operated in a servo feedback loop. The AO subsystem is operated using the remainder of the pump signal, serving as the reference (beacon) beam, which is transmitted together with the modulated signal photons. The power of the remaining pump signal is typically much higher than the power of the signal photons (e.g., the power of the modulated signal photons) but on a different wavelength. Based on the relative power of the remaining pump signal being greater than the power of the modulated signal photons, the remaining pump signal can be used as the reference or beacon beam for AO correction(s) applied by the AO subsystem and/or determined by the computing device 170 from the measurements obtained using the WFS 165. Because the AO corrections are applied to a combined signal comprising both the remaining pump signal and the modulated signal photons, AO corrections calculated based on the remaining pump signal and applied to the combined signal can be seen to compensate or correct turbulence effects and/or other FSO channel 145 distortions acting on the modulated signal photons as well as the remaining pump signal.

As noted previously above, the WFS 165 looks for wavefront distortions in a portion of the received beam that is provided to the WFS 165. For instance, the received beam can exit the compressing telescope 150, be reflected by a first mirror 154 to the deformable mirror 156 of the AO sub-system, and can subsequently be provided to a beam splitter (BS) 158. The beam splitter 158 can split the beam between the fiber coupler 162 and the WFS 165 of the AO sub-system. In some embodiments, the beam splitter 158 can use a 92% to 8% split of the incoming beam, with 92% being provided to the fiber coupler 162 for EA detection and 8% being provided to the WFS 165 for wavefront distortion detection and implementation of corresponding corrections using the deformable mirror 156 of the AO sub-system. The remaining unutilized pump signal is filtered out by an optical bandpass filter (with the central wavelength being 1550 nm) mounted on the 92% output branch/path of the BS 158, while the signal photons are unaffected by the optical bandpass filter.

In particular, the WFS 165 can be used to identify one or more wavefront distortions in the portion of the received beam that is provided to the WFS 165 from the beam splitter 158. One or more computing devices 170 coupled to the WFS 165 can subsequently be used to calculate the corresponding correction signals for the one or more wavefront distortions identified by the WFS 165. The corresponding correction signals calculated by the computing device 170 can be applied to deform the deformable mirror 156 in order to compensate for the wavefront distortions introduced or caused by the turbulent FSO link 145. In one illustrative example, the EA communication system 100 of FIG. 1 can perform greater than 350 AO corrections per second.

Fifth Stage (e.g., homodyne detection stage): in the fifth stage of the example EA communication system 100 of FIG. 1, the system 100 can perform homodyne detection using one or more of the balanced detector 175, the real-time scope (e.g., real-time oscilloscope or analog/digital (A/D) converter) 188, and the computing device 195. For example, after the AO stage (e.g., fourth stage), the portion of the received beam that is not split off for the AO subsystem (e.g., the 92% portion of the received beam remaining after the deformable mirror 156 and the beam splitter 158) can be coupled into a multimode fiber by the fiber coupler 162. The portion of the received beam coupled into the multimode fiber by the fiber coupler 162 can be used as the signal input of the balanced detector 175. In some embodiments, the balanced detector 175 can be a homodyne balanced detector.

The received beam coupled into the multimode fiber at the fiber coupler 162, and subsequently provided as input to the homodyne balanced detector 175, contains or represents the received/returning signal photons. To facilitate implementation, in at least some embodiments, the balanced detectors 175 can employ free-space coupling to the detectors rather than fiber-based coupling so that the multimode fiber with larger core diameter can be used to couple the received beam. As described above with respect to the first stage (photon generation stage) of the EA communication system 100 of FIG. 1, the signal photons are generated based on providing a first portion of the amplified EDFA output to the upper PPLN waveguide 116 and the WDM demultiplexer 125.

The idler photons can be kept on the transmitter side of the EA communication system 100 (e.g., the transmitter side including the entangled source and phase-conjugation module 110) and are first mixed with the remaining portion of the split 1529.75 nm pump signal from the EDFA 114. For instance, the first portion of the amplified EDFA output is provided from the EDFA 114 to the upper PPLN waveguide 116 to generate the signal photons; and the second portion of the amplified EDFA output can be provided from the EDFA 114 to the lower PPLN waveguide 118 to perform the mixing. The lower PPLN waveguide 118 can be used to perform phase-conjugation using a difference frequency generation (DFG) process. In some embodiments, the output of the upper PPLN waveguide 116 is passed through the WDM demultiplexer 125 to separate signal and idler photons. In some aspects, the 1510 nm idler photons can be passed to the lower PPLN waveguide 118 to perform the optical phase-conjugation. The phase-conjugated photons at 1550 nm are passed through an optical fiber that acts as a quantum memory implemented in the form of the reconfigurable optical delay line (ODL) 182. The length of the optical fiber used as the ODL 182 can be adjusted for the refractive index of the fiber. In an alternative scenario, the phase-conjugated idler photons can be distributed over a fiber link to the receiver side of the EA communication system 100 and stored in either a quantum memory or a respective ODL (e.g., the same as or similar to the transmitter side ODL 182 shown in FIG. 1) provided at the receiver side of the EA communication system 100.

By adjusting the length of the optical fiber used to implement the ODL 182, the arrival time for the returning signal photons (e.g., via the fiber coupler 162 and multimode fiber input to the balanced detector 175) and the phase-conjugated idler photons at the balanced detector 175 can be matched. In other words, the two inputs to the homodyne balanced detector 175 can be the returning signal photons (e.g., from the multimode fiber and fiber coupler 162/beam splitter 158) and the stored phase-conjugated idler photons (e.g., from the ODL 182), where the arrival times of the returning signal photons and stored idler photons are matched at the homodyne balanced detector 175 inputs.

An RF output from the homodyne balanced detector 175 is then re-sampled by an analog/digital (A/D) converter or a real-time oscilloscope 188 (e.g., shown in FIG. 1 as “Real-time scope” 188) and can be analyzed for bit-error rate (BER) of the transmitted information/EA communication that was transmitted over the turbulent FSO link 145. In some cases, the BER analysis can be performed in offline signal processing. In some cases, a performance comparison with classical communication in a back-to-back configuration can be determined in order to demonstrate the quantum advantage provided by the systems and techniques disclosed herein and/or the EA communication system 100 of FIG. 1. For instance, the reference can be a classical communication system using a 1550 nm laser signal that is BPSK modulated. Experimental results are summarized and described in the section below.

### Experimental Results

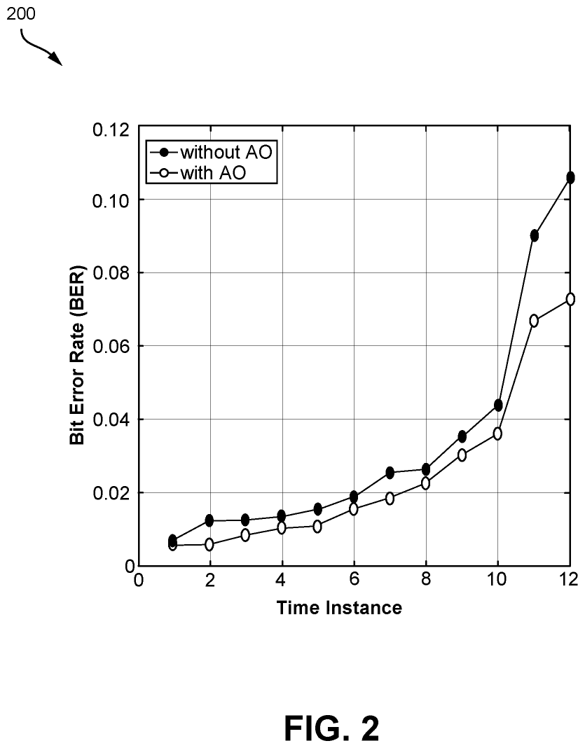

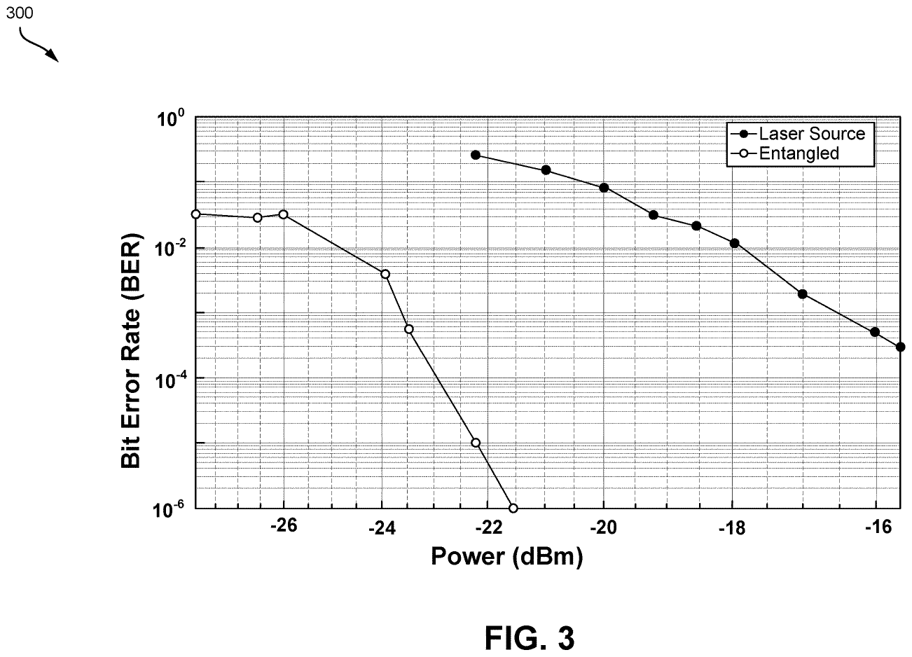

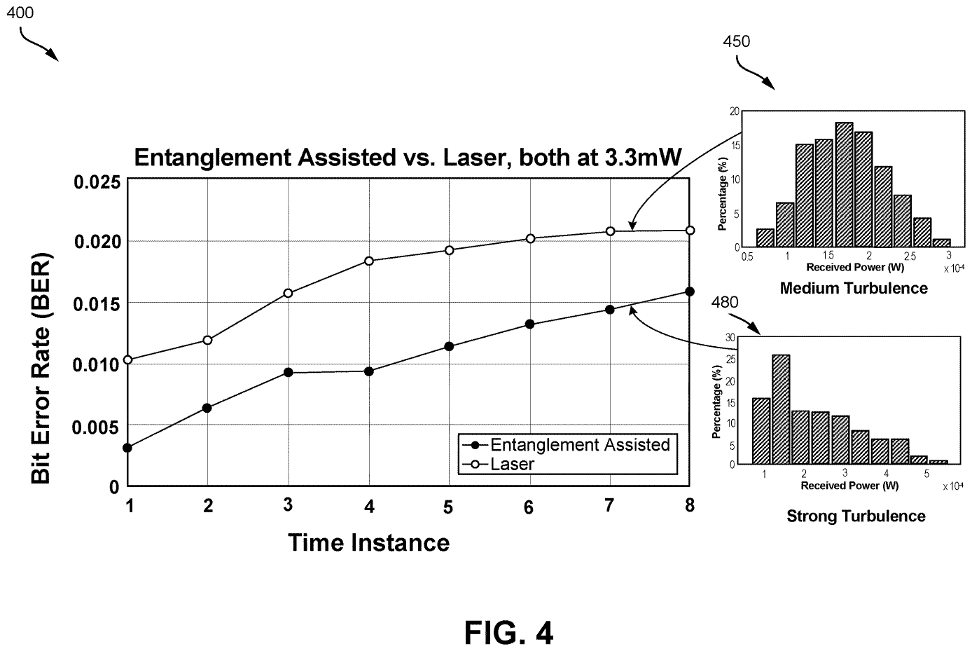

FIG. 2, FIG. 3, and FIG. 4 illustrate example plots 200, 300, and 400 (respectively) that are selected from numerous results collected in the experiments described herein for the EA communication system 100 of FIG. 1. In particular, FIG. 2 is a graph 200 showing an example of a bit-error rate (BER) of EA communications over an FSO link (e.g., such as turbulent FSO link 145 of FIG. 1), where the BER for the EA communications is calculated without the use of adaptive optics (AO), shown as the open circle data points, and calculated with the use of AO, shown as the closed/shaded circle data points on the graph 200.

FIG. 3 is a graph 300 showing an example of BER in a back-to-back configuration comparing EA and classical laser communications, in accordance with some examples. For example, the EA communications are represented in graph 300 as the “Entangled” communications associated with the open circle data points. Classical laser communications are represented in graph 300 as the “Laser Source” communications associated with the closed/shaded circle data points. As seen in graph 300 of FIG. 3, the EA communications achieve a significantly lower BER at significantly lower transmit power levels as compared to the classical laser communications. The EA communications/“Entangled” data points shown in graph 300 of FIG. 3 can correspond to EA communications performed using the EA communication system 100 of FIG. 1.

FIG. 4 provides an illustrative example demonstrating that EA communication (e.g., using the EA communication system 100 of FIG. 1) in a beyond strong turbulence regime of an FSO link (e.g., FSO link 145 of FIG. 1) can outperform the classical communication even when the classical communication technique is evaluated in the (more favorable/forgiving) medium turbulence regime. More particularly, graph 400 of FIG. 4 illustrates corresponding BERs for EA communications using the systems and techniques described herein and/or the EA communication system 100 of FIG. 1 (e.g., corresponding to the closed/shaded circle data points in graph 400), and corresponding BERs for conventional laser-based or classical communications (e.g., corresponding to the open circle data points in graph 400). FIG. 4 additionally illustrates a respective histogram of received power percentages corresponding to EA communication in the beyond strong turbulence regime (e.g., the received power percentage graph 480 corresponding to the EA communications) and illustrates a respective histogram of received power percentages corresponding to classical communication in the medium turbulence regime (e.g., the received power percentage graph 450 corresponding to the classical or laser-based communications).

In the graph 200 of FIG. 2, the results show the bit-error rate (BER) for an uncoded BPSK signal for EA communication over a time interval with deteriorating turbulence conditions (e.g., closed/shaded circle data points, “without AO”) and improvements made with the application of the disclosed adaptive optics EA communication system 100 to compensate for the wavefront distortion caused by atmospheric turbulence (e.g., open circle data points, “with AO”). The results are collected in the presence of strong turbulence on the FSO link 145. It can be seen that the use of adaptive optics helps to improve the BER performance for EA communications implemented using the systems and techniques described herein. The LDPC code corrected all the errors introduced by the turbulent channel 145 in this particular experiment.

In FIG. 3, depicted is a graph 300 presenting a comparison of entanglement assisted communication (e.g., open circle data points, “Entangled”) with the classical laser communications (e.g., closed/shaded circle data points, “Laser Source”) for an example uncoded case in a back-to-back configuration. As noted above, the reference for purposes of the comparison of FIG. 3 can be a classical communication system using a 1550 nm laser signal that is BPSK modulated. The same homodyne detector (e.g., balanced detector 175) is used in both cases. As depicted by the results presented herein, entanglement assisted communication significantly outperforms classical laser communication, exhibiting clear quantum advantage.

In FIG. 4, depicted is a graph 400 providing a comparison of EA communication (e.g., solid/shaded circle data points, “Entanglement Assisted”) in the beyond strong turbulence regime and classical communication (e.g., open circle data points, “Laser”) in the medium turbulence regime, for the same launch power. The EA communication link is operated in the beyond strong turbulence regime, described by the almost exponential distribution of received power. On the other hand, the classical link is operated in the medium turbulence regime characterized by the large variance of log-normal distribution of received power. Clearly, as can be seen in the BER comparison of graph 400 of FIG. 4, the EA communication in the beyond strong turbulence regime outperforms the classical communication in the medium turbulence regime, for the same launch power. The classical communication link was not operational at all in beyond strong turbulence regime (BER was 0.5).

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto. To illustrate, in an alternative scenario the entanglement source can be placed on a drone or a balloon and distribute the entanglement to the interested parties. LEO satellites or space platforms can also be used to distribute the entanglement.

What is claimed is:

1. A method comprising:
splitting an amplified pump beam into a first portion and a second portion;
providing the first portion of the amplified pump beam to a first periodically poled lithium niobate (PPLN) waveguide;
generating, using the first PPLN waveguide, entangled photon pairs comprising signal photons and idler photons, wherein the first PPLN waveguide generates the entangled photon pairs employing a spontaneous parametric down-conversion (SPDC) process;
separating, using a wavelength-division multiplexing (WDM) demultiplexer, the signal photons and the idler photons from the output of the first PPLN waveguide, wherein the signal photons are provided to a modulator to generate modulated signal photons, and wherein the idler photons are kept at a transmitter; and
transmitting the modulated signal photons using the transmitter,
wherein a remaining pump power after the first PPLN waveguide is also included in a transmitted beam of the transmitter and is used as a reference or beacon beam to operate an adaptive optics (AO) subsystem of a receiver associated with the transmitter.

2. The method of claim 1, wherein keeping the idler photons at the transmitter comprises:
combining the idler photons with the second portion of the amplified pump beam;
performing phase conjugation using a second PPLN waveguide, wherein the second PPLN waveguide receives as input the idler photons combined with the second portion of the amplified pump beam;
providing an output of the second PPLN waveguide to the WDM demultiplexer to bandpass phase-conjugated idler photons; and
distributing the phase-conjugated idler photons to the receiver using an optical fiber.

3. The method of claim 2, wherein:
the signal photons are associated with a wavelength of 1550 nanometers (nm);
the idler photons are associated with a wavelength of 1510 nm; and
the phase-conjugated idler photons are associated with a wavelength of 1550 nm.

4. The method of claim 3, wherein:
keeping the idler photons at the transmitter further comprises passing the 1550 nm phase-conjugated idler photons through a length of the optical fiber, where the optical fiber is configured as an optical delay line (ODL) to distribute the phase-conjugated photons to the receiver; and
the length of the optical fiber configured as the ODL is selected to match a propagation delay of the signal photons transmitted over a turbulent free-space optical (FSO) link between the transmitter and the receiver.

5. The method of claim 2, wherein the second PPLN waveguide performs optical phase-conjugation using a difference frequency generation (DFG) process.

6. The method of claim 2, further comprising:
using a receiver to receive a beam associated with the modulated signal photons transmitted over a free-space optical (FSO) link by the transmitter;
providing the received beam to an adaptive optics (AO) subsystem of the receiver, wherein the AO subsystem uses an unused pump signal included in the transmitted beam as the reference or beacon beam for determining a correction for applying to a deformable mirror to compensate for turbulence on the FSO link between the transmitter and the receiver; and
controlling the deformable mirror to receive the received beam while deforming in response to the correction determined by the AO subsystem, wherein the deformation of the deformable mirror generates a compensated received beam.

7. The method of claim 6, wherein:
the AO sub-system includes a wavefront sensor (WFS), the deformable mirror, and a computing device; and
the WFS and the deformable mirror operate in a feedback servo loop.

8. The method of claim 7, wherein:
a beam splitter provides a first portion of the compensated received beam to the WFS for determining the correction to apply to the deformable mirror; and
the beam splitter provides a remaining portion of the compensated received beam to a balanced detector via a multimode fiber.

9. The method of claim 8 wherein:
the balanced detector is included in a homodyne receiver configured to determine phase information;
the homodyne receiver includes the balanced detector and an optical hybrid; and
the balanced detector is free-space coupled such that a large core multi-mode fiber (MMF) can be used to couple received signal photons into the MMF.

10. The method of claim 9, wherein:
the second PPLN waveguide is used to perform optical phase-conjugation on the combination of the idler photons and the second portion of the amplified pump beam; and
the phase-conjugated idler photons are delayed using an optical fiber to distribute the phase-conjugated idler photons to the receiver, wherein the optical fiber comprises an optical delay line (ODL); and
the optical fiber comprising the ODL is configured to delay the phase-conjugated idler photons to the receiver such that an overall delay applied to the phase-conjugated idler photons by the ODL matches a propagation delay of signal photons transmitted over a turbulent FSO channel and provided to the homodyne detector as a local oscillator (LO) signal.

11. The method of claim 10, wherein a length of a distribution fiber of the ODL is configured to delay the phase-conjugated idler photons such that an arrival time of the delayed phase-conjugated idler photons is the same as an arrival time of the returning signal photons from the receiver.

12. The method of claim 7, wherein:
a transmitted beam from the transmitter includes the modulated signal photons and an unused pump power signal of the first PPLN waveguide that are transmitted over a turbulent free-space optical (FSO) link; and
the received beam obtained by the receiver is either a reflected or a redirected beam from an intermediate node, or a direct beam from a remote transmitter.

13. The method of claim 7, wherein:
the transmitter and the receiver are associated with communicating parties each capable of bidirectional transmission, wherein a respective transmitter and a respective receiver of each communicating party are included in a corresponding FSO transceiver associated with each communicating party.

14. The method of claim 1, further comprising:
using a tunable laser to generate a pump beam at a configured wavelength; and
generating, using an amplifier coupled to an output of the tunable laser, the amplified pump beam at the configured wavelength and with an increased power.

15. The method of claim 14, wherein:
the tunable laser comprises an S-band laser diode, a C-band laser diode, or an L-band laser diode; and
an output of the tunable laser is connected to an input of the amplifier, the amplifier comprising an Erbium-Doped Fiber Amplifier (EDFA).

16. The method of claim 15, wherein the configured wavelength associated with the tunable pump laser and the EDFA is 1529.75 nanometers (nm), or wherein the configured wavelength is selected based on tuning the tunable laser to a particular wavelength within one or more of S-, C-, or L-band wavelengths associated with the tunable laser.

17. The method of claim 1, wherein the signal photons have a wavelength of 1550 nanometers (nm) and the idler photons have a wavelength of 1510 nm.

18. The method of claim 1, wherein the demultiplexer is a wavelength-division multiplexing (WDM) demultiplexer.

19. The method of claim 1, wherein the phase conjugation of idler photons is performed on a receiver side or by a receiver of an entanglement assisted communication system.

20. The method of claim 1, wherein the phase conjugation of idler photons is performed on an intermediate node included between a transmitter and a receiver of an entanglement assisted communication system.
